(19) United States
(12) Patent Application Publication
(10) Pub. No.: US 2015/0188110 A1
(43) Pub. Date: Jul. 2, 2015

(54) BATTERY WITH HEAT-RESISTANT LAYER AND METHOD OF MANUFACTURING THE HEAT-RESISTANT LAYER

(71) Applicant: INDUSTRIAL TECHNOLOGY RESEARCH INSTITUTE, Chutung (TW)

(72) Inventors: Hsiu-Fen LIN, Taichung City (TW); Shih-Chieh LIAO, Jungli City (TW); Chia-Ming CHANG, Hsinchu City (TW); Min-Ling HOU, Kaohsiung City (TW); Yu-Hao HUANG, Kaohsiung City (TW); Chia-Chin LEE, Yuanchang Township (TW)

(73) Assignee: INDUSTRIAL TECHNOLOGY RESEARCH INSTITUTE, Chutung (TW)

(21) Appl. No.: 14/569,939

(22) Filed: Dec. 15, 2014

(30) Foreign Application Priority Data
Dec. 31, 2013 (TW) 102149209

(51) Int. Cl. H01M 2/16; H01M 2/18; H01M 2/14

(52) U.S. Cl. CPC H01M 2/1686; H01M 2/166; H01M 2/145; H01M 2/18

(57) ABSTRACT

A battery with a heat-resistant layer is provided. The battery with a heat-resistant layer includes a positive electrode, a negative electrode, a separator, an electrolyte and a heat-resistant layer. The separator is disposed between the positive electrode and the negative electrode. The heat-resistant layer is disposed between at least one of the positive or negative electrodes and the separator, wherein the heat-resistant layer has a tetrapod-shaped surface morphology. The positive electrode, the negative electrode, the separator and the heat-resistant layer are soaked in the electrolyte. A method for manufacturing the heat-resistant layer is also provided.

### CROSS REFERENCE TO RELATED APPLICATIONS

This application claims priority of Taiwan Patent Application No. 102149209, filed on Dec. 31, 2013, the entirety of which is incorporated by reference herein.

### TECHNICAL FIELD

The technical field relates to a battery, and in particular relates to a battery with a heat-resistant layer.

### BACKGROUND

In recent years, rechargeable secondary batteries are getting more attention since primary batteries do not meet environmental requirements. With the rapid development and popularity of portable electronic products, a Li-ion secondary battery is more widely used. than other batteries. A Li-ion secondary battery is advantageous over NiMH, Ni—Zn, and Ni—Cd batteries due to its high operating voltage, large energy density, light weight, long serve life, and environmental friendly feature, which also make it the best candidate for flexible battery. Li batteries are presently used to provide power to a wide variety of electronic devices, such as mobile phones, laptop computers, and digital cameras, and will play an important role in electric vehicle in the future.

To cope with future trend towards high capacity, high power, and large-scale power, high temperature performance and safety of a Li battery will be the main task of development. When the separator of a Li-ion battery heat shrinks due to overcharge or high temperature or is damaged by mechanical stress applied to the battery housing, it will result in direct contact of the positive electrode and the negative electrode so that a short circuit occurs, instantly releasing excessive current a id heat and potentially resulting in an explosion. If the short circuit cannot be shut down or local heat dissipation cannot be hindered, a series of reactions will be triggered within the battery to cause a fire, producing a great impact on safety.

Accordingly, there remains a need in the an to improve upon the safety and performance of a Li-ion battery.

### SUMMARY

An embodiment of the present disclosure provides a battery, including: as positive electrode; a negative electrode: a separator disposed between the positive electrode and the negative electrode; a heat-resistant layer having tetrapod-shaped surface morphology disposed between the separator and at least one of the positive electrode and the negative electrode; and an electrolyte, wherein the positive electrode, the negative electrode, the separator and an the heat-resistant layer are soaked in that electrolyte.

Another embodiment of the present disclosure provides a method of manufacturing a heat-resistant layer including: mixing 0.1-60 parts by weight of tetrapod-shaped powders, 0.1-30 parts by weight of a binder, and 99.8-10 parts by weight of a solvent to form 100 parts by weight of a dispersion; and processing the dispersion into a heat-resistant layer with tetrapod-shaped surface morphology between a battery electrode and a separator.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIG. 1 is a schematic diagram of a tetrapod-shaped powder in accordance with the exemplary embodiments:

FIG. 2 is a schematic diagram showing a cross-section of a heat-resistant layer having tetrapod-shaped surface morphology in accordance with the exemplary embodiments;

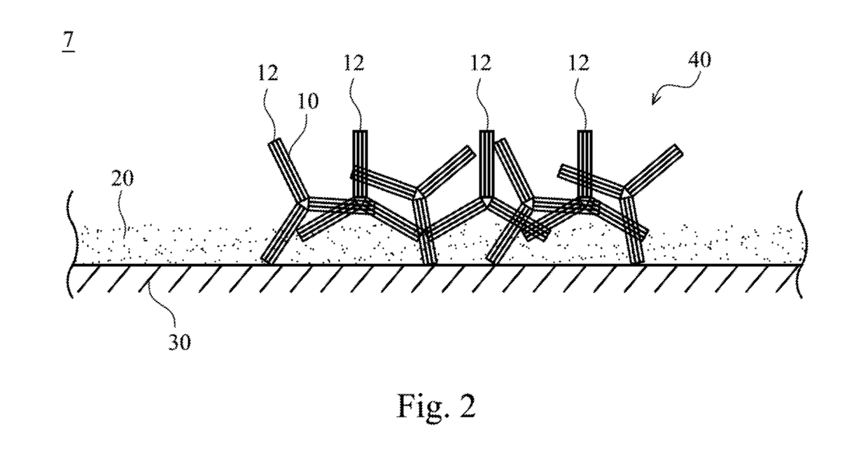

FIG. 3 is a schematic diagram showing a cross-section a battery with a heat-resistant layer in accordance with the exemplary embodiments;

FIG. 4A is an SEM photograph of tetrapod-shaped powders in accordance with the exemplary embodiments;

FIG. 4B is a TEM photograph of tetrapod-shaped powders in accordance with the exemplary embodiments;

FIG. 5A is an SEM top-view photograph of the negative electrode plate without a heat-resistant layer in accordance with the exemplary embodiments;

FIG. 5B is an SEM top-view photograph of the negative electrode plate with a heat-resistant layer having tetrapod-shaped surface morphology in accordance with the exemplary embodiments;

FIG. 6 is a line chart showing the cycling life test of batteries with/without a heat-resistant layer having tetrapod-shaped surface morphology in accordance With the exemplary embodiments;

FIG. 7 is a line chart showing the overcharge analysis of 18650 full battery without a heat-resistant layer in accordance with the exemplary embodiments;

FIG. 8 is a line chart showing the overcharge analysis of 18650 full battery with a heat-resistant layer having tetrapod-shaped surface morphology in accordance with the exemplary embodiments;

FIG. 9 is a line chart showing the light voltage micro-short circuit test of foil packed battery without as heat-resistant layer in accordance with the exemplary embodiments;

FIG. 10 is a line chart showing the light voltage micro-short circuit test of foil packed battery with a heat-resistant layer having tetrapod-shaped surface morphology in accordance with the exemplary embodiments;

FIG. 11 is a line chart showing the high temperature cycling life test of battery with a heat-resistant layer having round shaped surface morphology in accordance with the exemplary embodiments; and

FIG. 12 is a line chart showing the high temperature cycling life test of battery with a heart-resistant layer having tetrapod-shaped surface morphology in accordance with the exemplary embodiments.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The present disclosure provides a battery with a heat-resistant layer. The heat-resistant layer has tetrapod-shaped surface morphology and is disposed between a separator and at least one of a positive and negative electrode. The heat-resistant layer tetrapod-shaped surface morphology can hinder local heat dissipation when local short circuit occurs and the tetrapod-shaped powders in the heat-resistant layer can prevent direct contact of the positive electrode and the negative electrode if the separator melts and shrinks. A detailed description of method of manufacturing the heat-resistant layer is given in the following embodiments.

At first, in one embodiment, 0.1-60 parts by weight of tetrapod-shaped powders, 0.1-30 parts by weight of a hinder, and 99.8-10 parts by weight of a solvent are mixed evenly to form 100 parts by weight of a dispersion. In another embodiment, 5-30 parts by weight of tetrapod-shaped powders, 3-15 parts by weight of a binder, and 92-55 parts by weight of a solvent are mixed evenly to form 100 parts by weight of a dispersion.

The material of the tetrapod-shaped powders may include Zn, Sn, Mg, Al, Si, V, Zr, Ti, Ni, or alloys thereof oxides thereof, nitrides thereof, carbides thereof, or combinations thereof. The tetrapod-shaped powders may be formed by subjecting micro-powders of above-mentioned metal material to a plasma. In one embodiment, the method includes the steps of: generating a nitrogen plasma with electrodes of a plasma reactor at about 60 kW to about 80 kW; and introducing metal micro-powders through air as a carrier gas into the nitrogen plasma to vaporize and dissociate the metal micro-powders, wherein the flow rate of the carrier gas is about 8 slm to about 12 slm, the feed rate of metal micro-powders is about 0.5 kg/hr to about 2.0 kg/hr, and the nitrogen-containing atmosphere is controlled at about 0.5 bar to about 2 bar such that the vaporized metal atom can he oxidized by oxygen molecules to form metal oxide nano-powders through nucleation. A large amount of cooling gas, such as a mixture gas of nitrogen and air, can be introduced at a flow rate of about 3000 slm to about 4000 slm to quench the metal oxide powders. The overall process of the above-mentioned steps is completed in about 10⁻¹ to about 10⁻² seconds. In another embodiment, the similar steps are carried out while using nitrogen as a carrier gas to obtain metal nitride tetrapod-shaped powders. The manufacturing process and characteristics of the tetrapod-shaped powders are described in detail in commonly assigned U.S. Patent Publication No. 2005/0249660, the entirely of which is incorporated by reference herein.

The tetrapod-shaped powders can constitute a three dimensional (3D) protecting structure in the subsequently formed heat-resistant layer. Accordingly, when the separator shrinks due to local short circuit, the 3D protecting structure can prevent direct contact of the positive electrode and the negative electrode from occurring) avoid complete short circuit, In addition, the battery with a heat-resistant layer having tetrapod-shaped powders has a longer high temperature cycling life in a high temperature (40-60° C.) environment, compared to the counterpart without the heat resistant layer.

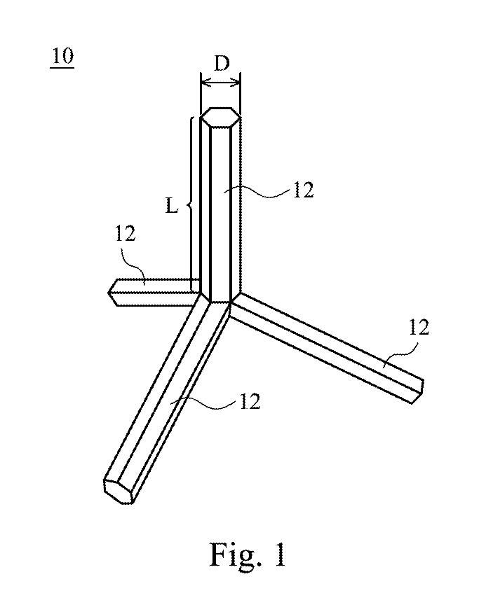

Referring to FIG. 1, a schematic diagram of a tetrapod-shaped powder 10 is illustrated in accordance with an exemplary embodiment. As shown in the figure, the tetrapod-shaped powder 10 includes four rods 12. In one embodiment, each rod 12 has a length L of about 10 nm to about 5 μm. In another embodiment, the length L of each rod 12 is about 50 nm to about 1 μm. In addition, one embodiment, each rod 12 has a diameter D of about 10 nm to about 2 μm. In another embodiment, the diameter D of each rod 12 is about 30 nm to about 500 nm. It should be noted that if the tetrapod-shaped powder has an overly short length L, e.g. less than about 10 nm, the porosity of the formed heat-resistant layer may too small to allow transportation of ions, which will increase internal resistance of the battery. However, if the tetrapod-shaped powder has an overly long length L, e.g. more than about 5 μm, the tetrapod-shaped powders will be unevenly dispersed in the formed heat-resistant layer and the porosity of the formed heat-resistant layer may be too large to effectively improve safety of the battery. Furthermore, if the tetrapod-shaped powder has an overly small diameter D. e.g., less than about 10 nm, the rod 12 of the tetrapod-shaped powder may break in dispersion process. However, if the tetrapod-shaped powder has an overly large diameter D, e.g. more than about 2 μm, the formed heat-resistant layer may have higher impedance that will increase internal resistance of the battery.

The binder serves to bind the tetrapod-shaped powders to each other and to the surface of battery components, such as positive electrode, negative electrode or separator. In one embodiment, the binder may be polyvinylidene fluoride, polyhexafluoropropylene-polyvinylidene fluoride, ethylene-tetrafluoroethylene, polychlorotrifluoroethylene, polyvinyl acetate, polyvinyl alcohol, polyethylene oxide, polyvinyl pyrrolidone, alkylated polyethylene polyvinyl ether, polymethylmethacrylate, polyethylacrylate, polytetrafluoroethylene, polyacrylonitrile, resins with acrylonitrile unit, or combinations thereof.

The solvent serves to uniformly disperse the tetrapod-shaped powders and the binder in the solution to prevent aggregation thereof. In one embodiment, the solvent may be an organic solvent, such as N-methyl-2-pyrrolidone, methyl isobutyl ketone, methyl ether ketone, ketone, methyl ethyl ketone, toluene, xylene, mesitylene, fluorotoluene difluorotoluene, trifluorotoluene N,N-dimethylacetamide, or combinations thereof.

In one embodiment, after the dispersion is formed, the dispersion is directly coated on the positive electrode, negative electrode, or separator of the battery. In another embodiment, the formed dispersion is processed into a layer with tetrapod-shaped surface morphology, which is then disposed between the separator and the positive electrode or between the separator and the negative electrode.

In one embodiment, after the dispersion is formed, the dispersion is coated on the positive electrode, negative electrode, or separator of the battery. Then, the dispersion is dried to form the heat-resistant layer with tetrapod-shaped surface morphology. In another embodiment, the formed dispersion is first processed into a layer with tetrapod-shaped surface morphology, before it is disposed between the separator and the positive electrode or between the separator and the negative electrode. In the embodiment, the method of processing the formed dispersion into the layer with tetrapod-shaped surface morphology may be, but not limited to, die coating, micro gravure coating, spin coating, casting, bar coating, blade coating, roller coating, wire bar coating, dip coating, or the like. In some embodiments, the drying step is carried out at about 30° C. to about 150° C. for about 0.5 minutes to about 60 minutes. In another embodiments, the drying step is carried out at about 50° C. to about 90° C. for about 1 minutes to about 3 minutes. It should he noted that if the drying process is performed at art overly high temperature, e.g. higher than 150° C., the formed heat-resistant layer may warp due to thermal stress. However, if the drying process is performed at an overly low temperature, e.g. lower than 30° C., it will result in incomplete drying. Furthermore, if the drying process is performed for overly long time, e.g. more than 60 minutes, the binder may crack due to the prolonged heating. However, if the drying process is performed for overly short time, e.g. less than 0.5 minutes, it will also result in incomplete drying.

Referring to FIG. 1 a cross-sectional view of the heat-resistant layer 7 with tetrapod-shaped surface morphology 40 is illustrated in accordance with the exemplary embodiments. As shown in the figure, the heat-resistant layer 7 with tetrapod-shaped surface morphology 40 located on a surface of a battery component 30 includes the tetrapod-shaped powders 10 and the binder 20. The surface of battery component 30 can be a surface of a positive electrode, a negative electrode, or a separator. For example, the heat-resistant layer 7 with tetrapod-shaped surface morphology 40 may be deposited on the surface of a negative electrode.

In one embodiment, the weight ratio of the tetrapod-shaped powders and the binder in the heat-resistant layer 7 may be roughly the same as in the dispersion mentioned above. That is, the heat-resistant layer 7 with tetrapod-shaped surface morphology 40 may include about 0.1-60 parts by weight of the tetrapod-shaped powders 10 and about 0.1-30 parts by weight of the binder 20. In another embodiment, the heat-resistant layer 7 with tetrapod-shaped surface morphology 40 may include about 5-30 parts by weight of the tetrapod-shaped powders 10 and about 3-15 parts by weight of the binder 20.

When the tetrapod-shaped powders 10 are adhered to the surface of the battery component 30, due to the good standing ability of tetrapod-shaped powders 10, at least one rod 12 of the tetrapod-shaped powder 10 will protrude from the surface Of the heat-resistant layer 7, thereby forming the tetrapod-shaped surface morphology 40.

In some embodiments, the heat-resistant layer 7 with tetrapod-shaped surface morphology 40 is disposed between the separator and at least one of the positive and negative electrode. Furthermore, the tetrapod-shaped powders 10 will interdigitate with each other to form a butter area which has protection function for improving the battery safety but not so dense as to block ion transportation. For example, the heat-resistant layer 7 with tetrapod-shaped surface morphology 40 can prevent direct contact of the positive electrode and the negative electrode and avoid, local short circuit when the separator of the battery is locally damaged. In addition, the heat-resistant layer 7 with tetrapod-shaped surface morphology 40 can prevent the battery from complete short circuit when the separator heat-shrinks or melts. Moreover, instead of decreasing the battery serve life, the installation of the heat-resistant layer 7 actually improves the stability of battery at high temperatures, thus prolonging the cycle life of a battery.

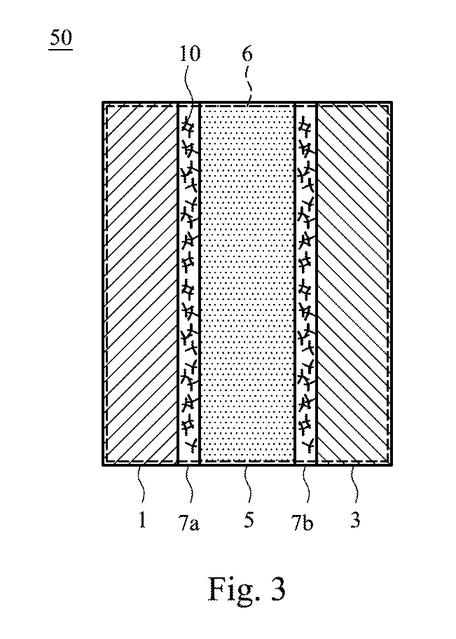

Referring to FIG. 3, a cross-sectional view of a battery 50 with heat-resistant layers (7a, 7b) are illustrated in accordance with the exemplary embodiments. As shown in the figure, the battery 50 includes a pair of a positive electrode 1 and a negative electrode 3, a separator 5 between the positive electrode 1 and the negative electrode 3, and the heat-resistant layers (7a, 7b) are disposed respectively between the positive electrode 1 and the separator 5 and between the negative electrode 3 and the separator 5, wherein the heat-resistant layer (7a, 7b) has tetrapod-shaped surface morphology. It should he noted that while two heat-resistant layers (7a, 7b) are shown in figure, the battery 50 can only have the heat-resistant layer 7a disposed between the positive electrode 1 and the separator 5 or the heat-resistant layer 7b disposed between the negative electrode 3 and the separator 5. The positive electrode 1, negative electrode 3, separator 5, and heat-resistant layers (7a, 7b) are all impregnated in an electrolyte solution 6.

The positive electrode 1 may be lithium iron phosphate, lithium manganese oxide, lithium cobalt oxide, lithium nickel cobalt oxide, lithium nickel manganese oxide, lithium nickel manganese cobalt oxide, or lithium-rich layered cathode material.

The negative electrode 3 may be carbide, lithium titanium oxide, silicon carbon composite material, tin alloy, or other metal compound. The carbide may include carbon powder, graphite, hard carbon, soft carbon, carbon fiber, carbon nanotube, or combinations thereof. In one embodiment, the carbide is carbon powders having a particle size of about 1 μm to about 30 μm. In some embodiments, the negative electrode 3 may further contain a binder, such as polyvinylidene fluoride, styrene-butadiene rubber, polyamide, or melamine resin.

The separator 5 may be an insulation material, such as polyethylene, polypropylene, or a multilayer film thereof, e.g. PE/PP/PE, or the like.

The major components of the electrolyte solution 6 may include an organic solvent, a lithium salt, and an additive. The organic solvent may be γ-butyrolactone, ethylene carbonate, propylene carbonate, diethyl carbonate, propyl acetate, dimethyl carbonate, ethylmethyl carbonate, or combinations thereof. The lithium salt may be LiPF₆, LiBF₄, LiAsF₆, LiSbF₆, LiClO₄, LiAlCl₄, LiGaCl₄, LiNO₃, LiC(SO₂CF₃)₃, LiN(SO₂CF₃)₂, LiSCN, LiO₃SCF₂CF₃, LiC₆F₅SO₃, LiO₂CCF₃, LiSO₃F, LiB(C₆H₅)₄, LiCF₃SO₃, LiBi(C₂O₄)₂, or combinations thereof.

In some embodiments, the heat-resistant layer (7a and/or 7b) is coated on the positive electrode 1 and/or negative electrode 3. In the embodiments, the heat-resistant layer (7a and/or 7b) has a first side facing towards the positive electrode 1 and/or negative electrode 3, and a second side with tetrapod-shaped surface morphology facing towards the separator 5, wherein the first side has a porosity smaller than the second side. In other embodiments, the heat resist it layer (7a, 7b) is individually or additionally the separator 5. In the embodiments, the heat-resistant layer (7a, 7b) has a first side lacing towards the separator 5, and a second side with tetrapod-shaped surface morphology facing towards the positive electrode 1 or negative electrode 3, wherein the first side has a porosity smaller than the second side.

By disposing the heat-resistant layer with tetrapod harped surface morphology between the separator and at least ogre of the positive electrode and negative electrode, the battery of the disclosure can prevent direct contact of the positive electrode and negative electrode when he separator be locally damaged, thus avoiding local short circuit. In addition, tetrapod-shaped powders in the heat-resistant layer can prevent complete short circuit of the battery when the separator heat-melts or shrinks at high temperature. Moreover, instead of decreasing the battery serve life, the installation of the heat-resistant layer improves the stability of battery at high temperatures, thus prolonging the high temperature cycling life.

In one embodiment, the thickness of the heat-resistant layer with tetrapod-shaped surface morphology may be about 0.1 μm-20 μm. In another embodiment, the thickness of the heat-resistant layer with tetrapod-shaped surface morphology may be about 0.5 μm-10 μm. It should be noted that if the heat-resistant layer with tetrapod-shaped surface morphology has an overly large thickness, e.g. more than 20 μm, the heat-resistant layer may impede transportation of ions and in internal resistance of the battery. However, if the heat-resistant layer with tetrapod-shaped surface morphology has an overly small thickness, e.g. less than 0.1 μm, the heat resistant a may can't prevent direct contact of the positive electrode and negative electrode effectively, decreasing the protection performance.

In summary, by disposing the heat-resistant layer with tetrapod-shaped surface morphology between the separator and at least one of the positive electrode and negative electrode, the heat dissipation during local short circuit can be hindered and the direct contact of the positive electrode and negative electrode can be avoided to prevent complete short circuit. Thus, improving safety of the battery significantly. In addition, the heat-resistant layer can increase high temperature cycling life of the battery.

Below, exemplary embodiments will be described in detail with reference to accompanying drawings so as to be easily realized, by a person having ordinary knowledge in the art, The inventive concept may be embodied in various forms without being limited to the exemplary embodiments set forth herein. Descriptions of well-known parts are omitted for clarity, and like reference numerals refer to like elements throughout.

### EXAMPLES

### Preparing Tetrapod-Shaped Powders

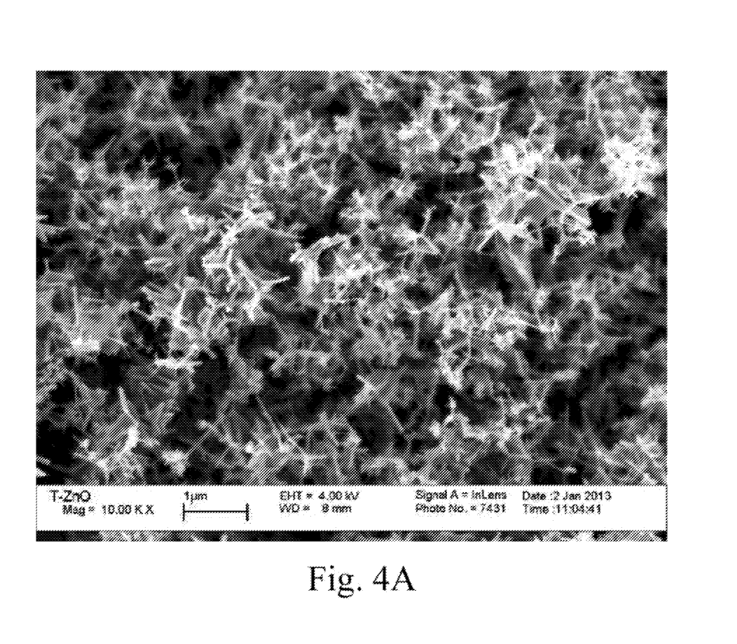

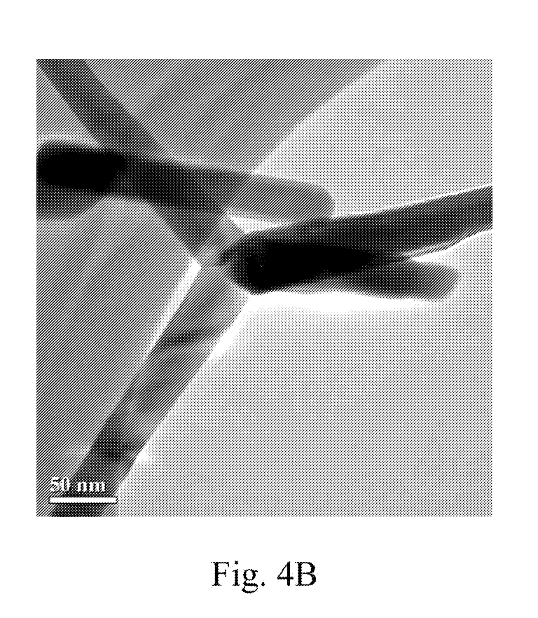

100 slm of nitrogen was introduced into a plasma reactor and dissociated to generate a plasma at an energy of about 80 kW. After the plasma reached steady state. Zn-wires having a diameter of 1.66 mm and a purity of 99.9% were delivered to the plasma using air as a carrier and protection gas and were liquefied and vaporized immediately. In the above process, the flow rate of the carrier gas was about 10 slm and the feed rate of the Zn-wires was about 1.0 kg/hr. The vaporized Zn metal atoms were contacted to a large amount of cooling gas and oxidized via reacting with oxygen molecules of the cooling gas to form tetrapod-shaped metal oxide nano-powders through nucleation, wherein the flow rate of the cooling gas was about 3000 slm to about 4000 slm. The overall process from liquefying the Zn-wires to forming the tetrapod-shaped metal oxide nano-powders was completed in about 10⁻² to about 10⁻¹ seconds. The formed tetrapod-shaped metal oxide nano-powders are shown in FIG. 4A-4B, wherein FIG. 4A is an SEM photograph of the tetrapod-shaped powders and FIG. 4B is a TEM photograph of the tetrapod-shaped powders.

### Preparing a Dispersion

10 parts by weight of tetrapod-shaped powders were added into 87 parts by weight of DMAC solvent and then stirred evenly with a high power mixer to form a solution. 3 parts by weight of PPM; binder were added into the above solution and then stirred evenly with a high power mixer to form a dispersion having a viscosity of about 286 cps.

### Coating a Heat-Resistant Layer Having Tetrapod-Shaped Surface Morphology

A heat-resistant layer having tetrapod-shaped surface morphology was coated by a slot-die coater by the following steps:
1. pouring the above dispersion into a feed tank and circulated by a motor speed of 35 Hz;
2. placing a coated negative electrode plate on a delivering roller arid transported with a velocity of 5 m/min;
3. opening the exit slit to coat the dispersion evenly on the negative electrode plate; and
4. conveying the negative electrode plate to the dry unit for continuous drying at a temperature of 120-130° C.

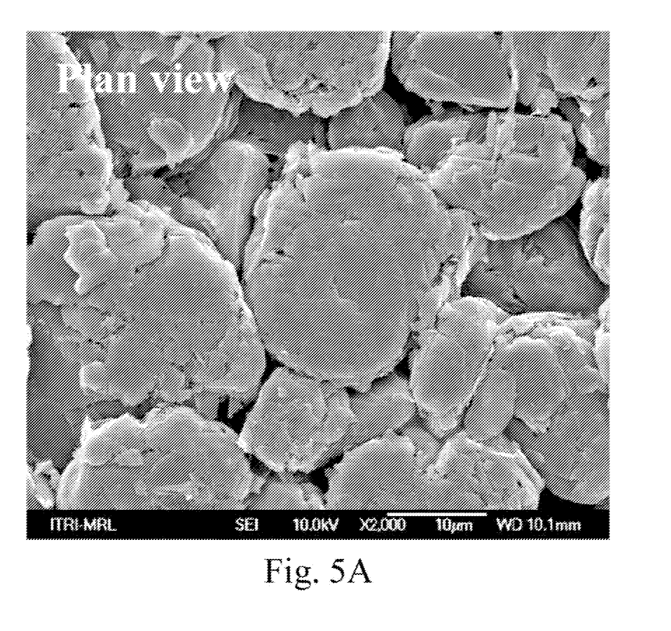

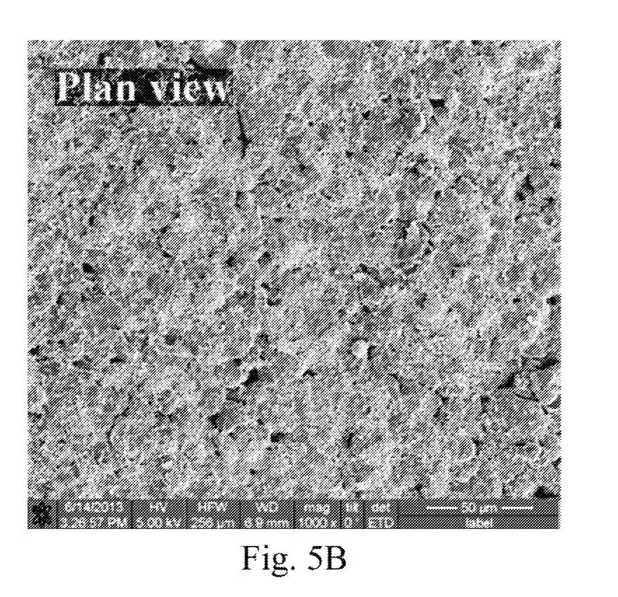

A negative electrode plate with heat-resistant layer having tetrapod-shaped surface morphology was formed by the drying, which had a length of 20 m. The negative electrode plate with the heat-resistant layer having tetrapod-shaped surface morphology is shown in FIG. 5A-5B, wherein FIG. 5A is an SEM top-view photograph of the negative electrode plate without a heat-resistant layer and FIG. 5B is an SEM top-view photograph of the negative electrode plate with a heat-resistant layer having tetrapod-shaped surface morphology.

### Assembling a Battery

A 18650 type cylindrical battery and a battery with foil pack were respectively assembled by following processes:
a. 18650 type battery:
1. cutting a positive electrode plate into a size of 81 cm in length and 55 mm in width, and cutting the negative electrode plate into a size of 87 cm in length and 57 mm in width according to the designed capacity;
2. soldering an aluminum conductive handle on the positive electrode with ultrasonic welding machine;
3. soldering a nickel conductive handle on the negative electrode with ultrasonic welding machine;
4. drying the positive and negative electrode with conductive handles at 120° C. for 10 hours;
5. assembling and winding the combination of the positive plate/separator/negative plate, wherein the separator was Celgard M824 12 μm PP/PE/PP trilayer separator;
6. inserting the wound assembly into a cylindrical battery case can with 18 mm in diameter a 650 mm in height and then spot welding at the bottom;
7. winding a belt around the battery case at a height of 60 mm and then laser welding a cap;
8. vacuum injecting a three-component electrolyte solution (DC/DMC/EMC 1:1.1+2% VC); and
9. finally, sealing the batter case with a sealing machine and then putting on an insulation plastic film to complete the process.
b. Battery with foil pack:
1. cutting a positive electrode plate into a size 35 cm in length and 49 mm in width and cutting the negative electrode plate into a size of 38 cm in length and 51 mm in width according to the designed capacity;
2. soldering an aluminum conductive handle on the positive electrodes with ultrasonic welding machine;
3. soldering a nickel conductive handle on the negative electrode with ultrasonic welding machine;
4. drying the positive and negative electrode with conductive handles at 120° C. for 10 hours;
5. assembling and winding the combination of the positive plate/separator/negative plate, wherein the negative plate had a heat-resistant layer haying tetrapod-shaped surface morphology and the separator was Celgard M824 12 μm PP/PE/PP trilayer separator;
6. inserting the wound assembly into an aluminum foil battery ease and sealing the battery case at side surface with a sealing machine;
7. vacuum injecting a three-component electrolyte solution (EC/DMC/EMC 1:1:1+2% VC); and
9. sealing the battery case with as sealing machine.

### Cycling Life Test

### Comparative Example 1

### The Battery without a Heat-Resistant Layer

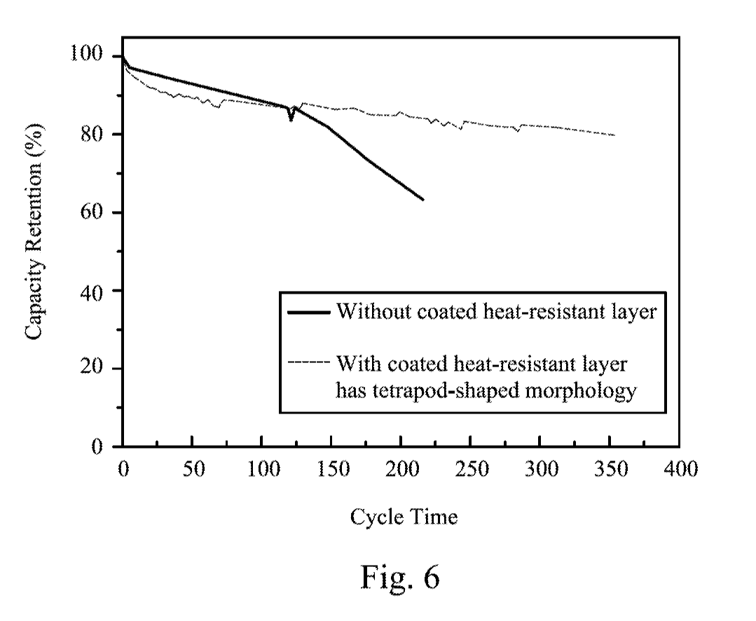

A layer of SnOₓ—LiNi_{0.5}Co_{0.2}Mn_{0.3}O₂ was coated on a positive electrode plate and a graphite was coated on a negative electrode plate to assemble a 18650 type full battery. Herein, the negative electrode plate was not coated with a heat-resistant layer. The result of cycling life test of the 18650 type full battery at 55° C. is shown in FIG. 6. The capacity retention of the battery without a heat-resistant layer decreased to 80% after 160 charge-discharge (5 C-1 C) cycles. After 225 charge-discharge (5 C-1 C) cycles, the capacity retention further decreased to 65%.

### Example 1

### The Battery with a Heat-Resistant Layer Having Tetrapod-Shaped Surface Morphology

A layer of SnOₓ—LiNi_{0.5}Co_{0.2}Mn_{0.3}O₂ was coated on a positive electrode plate and a graphite and a heat-resistant layer having tetrapod-shaped surface morphology were sequentially coated on a negative electrode plate to assemble a 18650 type full battery. The result of cycling life test of the 18650 type full battery at 55° C. is shown in FIG. 6. The capacity retention of the battery with a heat-resistant layer still retained. 80% after 375 charge-discharge 5 C-1 C cycles.

Note that it is generally held that the heat-resistant layer would decrease the cycling life of a battery because a non-conductive, heat-resistant layer is additionally provided between the electrode plate and the separator. However, instead of decreasing the cycling life, the battery with the heat-resistant layer having tetrapod-shaped surface morphology has a longer cycling life than the counterpart without the heat-resistant layer. Therefore, it is surprising and unexpected that the battery with a heat-resistant layer having tetrapod-shaped surface morphology would improve the thermal stability and thereby increasing the cycling life of the battery.

### Overcharge Safety Test

### Comparative Example 2

### A Battery without a Heat-Resistant Layer

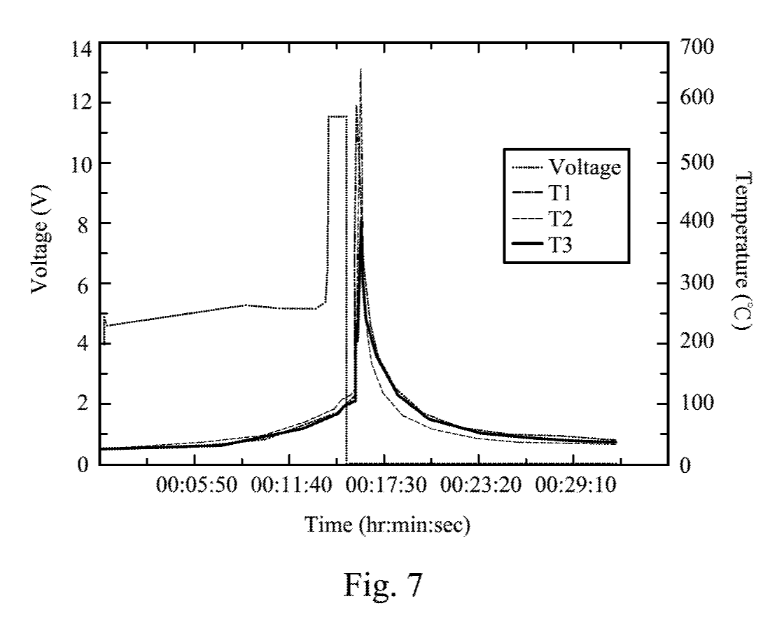

A line chart of overcharge analysis of a 18650 full battery without a heat-resistant layer is shown in FIG. 7, wherein T1, T2, and T3 are respectively the surface temperatures of the front-end, middle, and back-end of the battery. As shown in the figure, when the 18650 full battery was charged to a voltage of 12V with a charging speed of 3 C, T1, T2, and T3 were slowly increased with the voltage. When the voltage was reached about 12V and maintained for 1 minute, the separator started to shrink to cause local short circuit. Then, the direct contact of the positive electrode plate and the negative electrode caused a series of thermal runaway and complete short circuit of the battery, and finally resulted in burning and battery explosion. At this moment, the voltage decreased to 0V immediately and the temperature reached the highest of 650° C. After the overcharge test, the 18650 full battery without a heat-resistant layer was burned and charred because of the complete short circuit.

### Example 2

### A Battery with Heat-Resistant Layer Having Tetrapod-Shaped Surface Morphology

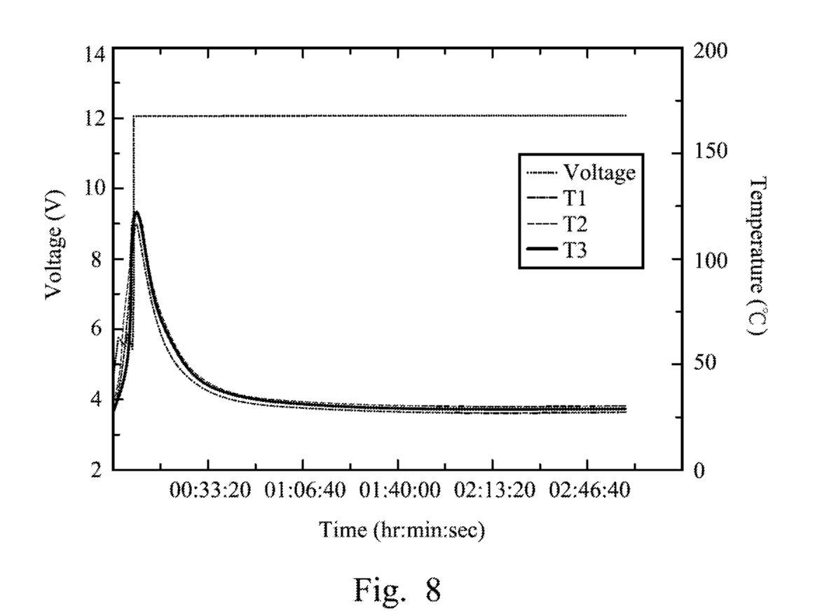

A line chart of overcharge analysis of a 18650 full battery with the heat-resistant layer having tetrapod-shaped surface morphology coated on be negative electrode plate is shown in FIG. 8, wherein T1, T2, and T3 are respectively the surface temperatures of the front-end, middle, and back-end of the battery. As shown in the figure, when the 18650 full battery was charged to a voltage of 12V with a charging speed of 3 C, T1, T2, and T3 with the voltage. When the voltage reached about 12V, the surface temperature of battery increased to the highest of about 115° C. At this moment, the separator started to shrink, but the heat-resistant layer having tetrapod-shaped surface morphology of the battery prevented the positive electrode plate and the negative electrode from direct contact, thus avoiding the occurrence of complete short circuit. As a result, the surface to temperature of battery did not increased but decreased to a room temperature. After the overcharge test, the battery was not burned because the heat-resistant layer having tetrapod-shaped surface morphology effectively prevented the battery from front complete short circuit. Compared to Comparative Example 2, the heat-resistant layer having tetrapod-shaped surface morphology in Example 2 significantly improved the performance of overcharge prevention and safety of battery.

### Light Voltage Micro-short Circuit Test

### Comparative Example 3

### A Battery without a Heat-Resistant Layer

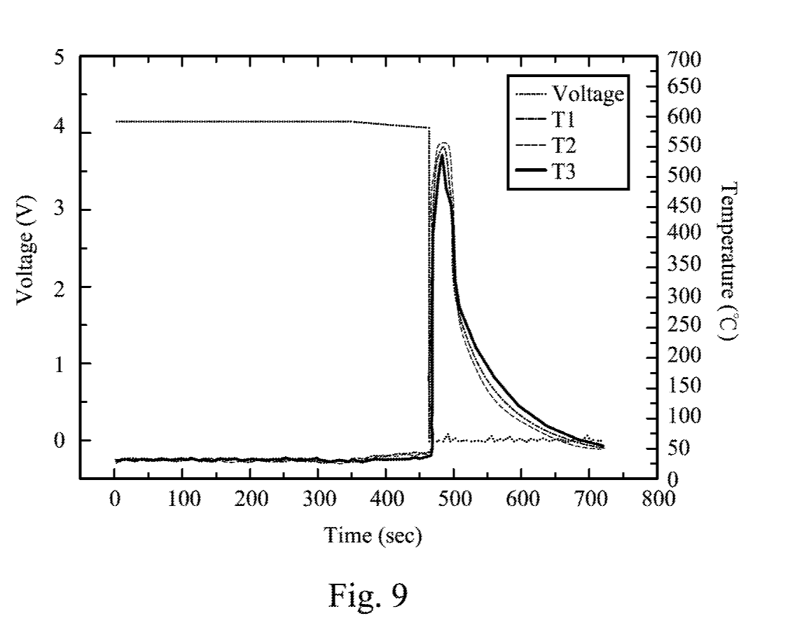

A line chart of light voltage micro-short circuit test of a foil packed battery without a heat-resistant layer shown in FIG. 9, wherein T1, T2, and T3 are respectively the surface temperatures of the front-end, middle, and back-end of the battery. In the light voltage micro-short circuit test, a fully charged foil packed battery without a heat-resistant layer was punched by a round blunt needle having a diameter 2.5 mm with a speed of 0.015 mm/sec until the voltage decreased to 25 mV. As shown in the figure, when the round blunt needle started to contact the surface of battery, a local short circuit occurred with slow ramp-down of the voltage and slow amp-up of the surface temperature. After the voltage decreased to 25 mV, the needle punch stopped, acid a complete short circuit soon occurred, and the voltage abruptly dropped down and the temperature abruptly rose to near about 600° C. After the light voltage micro-short circuit test, the foil packed battery without a heat-resistant layer burned and charred because of the occurrence of complete short circuit.

### Example 3

### A Battery with a Heat-Resistant Layer Having Tetrapod-Shaped Surface Morphology

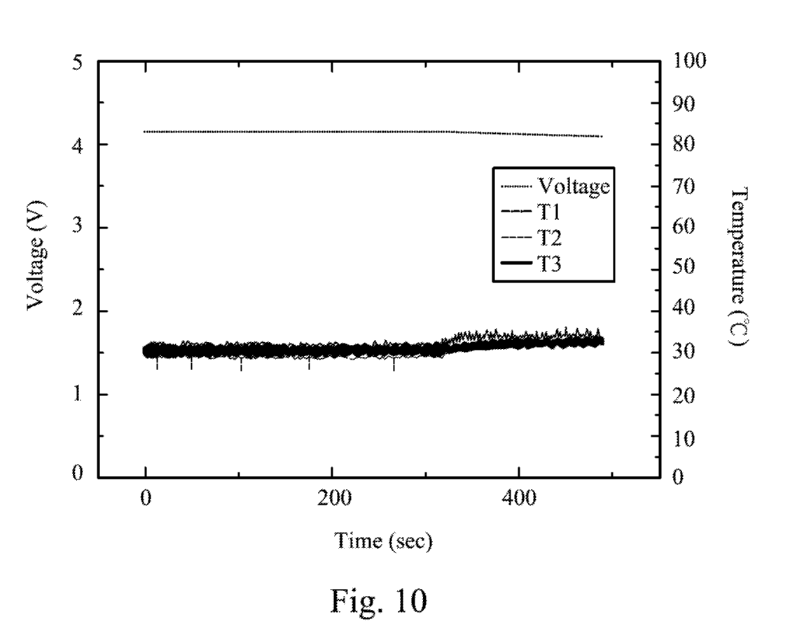

A line chart of light micro-short circuit test of a foil packed battery with a heat-resistant layer having tetrapod-shaped surface morphology is shown in FIG. 10, wherein T1, T2, and T3 are respectively the surface temperatures of the front-end, middle, and back-end of the battery. In the light voltage micro-short circuit test, a fully charged foil packed battery with the heat-resistant layer having tetrapod-shaped surface morphology was punched by a round blunt needle having a diameter of 2.5 mm with a speed of 0.015 mm/sec until the voltage decreased to 25 mV. As shown in the figure, when the round blunt needle started to contact the surface of battery, a local short circuit occurred with slow ramp-down of the voltage and slow ramp-up of the surface temperature. After the voltage decreased to 25 mV, needle punch stopped, and the battery temperature remained less than 35° C. and the voltage remained above 4V. This indicates that the heat resistant layer having tetrapod-shaped surface morphology in the battery prevented local short circuit from propagating to complete short circuit. Therefore, after the light voltage micro-short circuit test, the battery did not burn. Compared to Comparative Example 3, the heat-resistant layer having tetrapod-shaped surface morphology in Example 3 effectively prevented a local short circuit from propagating to complete short circuit and thus, no large amount heat was released and the safety of battery was significantly improved.

### Comparison of Effects of Heat-Resistant Layers Having Different Morphology on High Temperature Cycling Life of Battery

### Comparative Example 4

### A Battery with a Heat-Resistant Layer Having Round-Shaped Surface Morphology

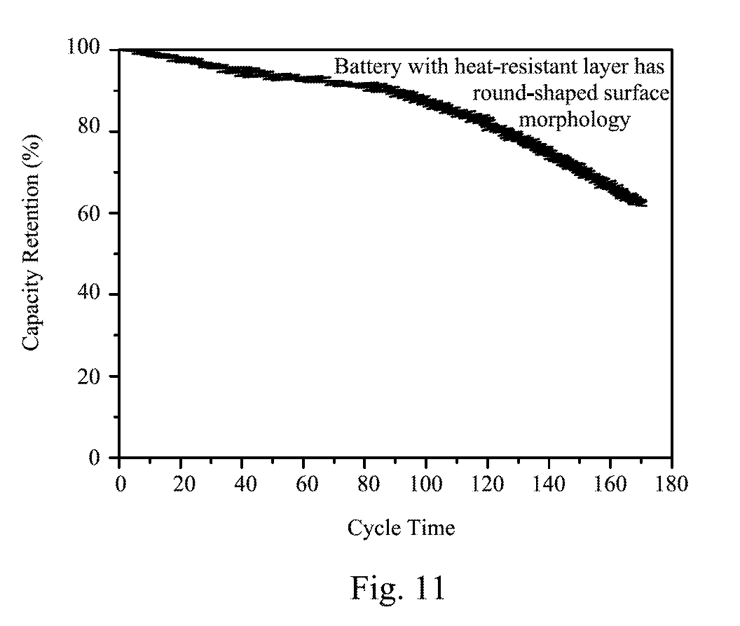

A layer of SnOₓ—LiNi_{0.5}Co_{0.2}Mn_{0.3}O₂ was coated on a positive electrode plate and a graphite and a heat-resistant layer having round-shaped morphology (round-shaped powders of aluminum oxide) were sequentially coated on a negative electrode plate to assemble a 18650 type full battery. The result of the high temperature cycling life test of the 18650 type full battery is shown FIG. 11, wherein the test was carded out at speeds of 0.5 C-1 C (charge-discharge) at 55° C. After 125 charge-discharge cycles, the capacity retention of the battery decreased to 80%. Then, after 170 cycles, the capacity retention of the battery was only 60%.

### Example 4

### A Battery with a Heat-Resistant Layer Having Tetrapod-Shaped Surface Morphology

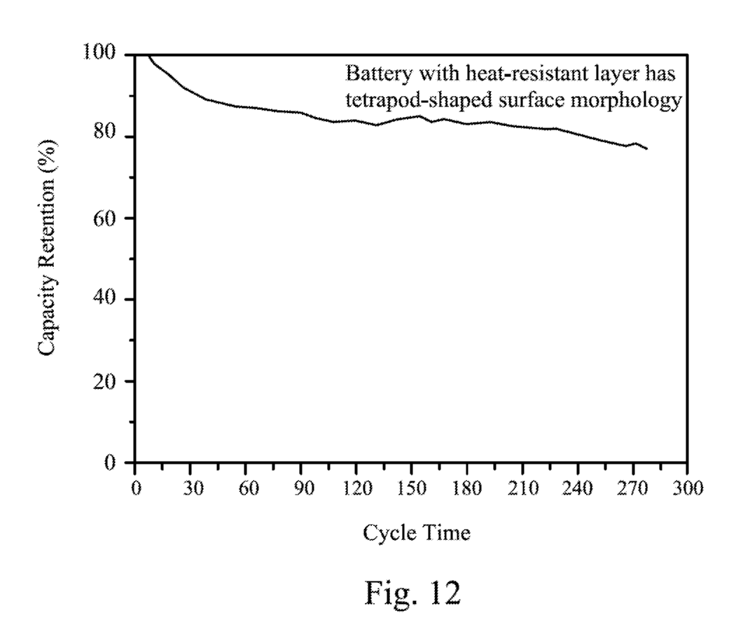

A layer of SnOₓ—LiNi_{0.5}Co_{0.2}Mn_{0.3}O₂ was coated on a positive electrode plate and a graphite and a heat-resistant layer had tetrapod-shaped surface morphology were sequentially coated on a negative electrode plate to assemble a 18650 type full battery. The result of the high temperature cycling life test of the 18650 type full battery is shown in FIG. 12, wherein the test was carried out at speeds of 0.5 C-1 C (charge-discharge) at 55° C. After 260 charge-discharge cycles, the capacity retention of the battery still retained 80%.

It will be apparent to those skilled in the art that various modifications and variations can be made to the disclosed embodiments. It is intended that the specification and examples be considered as exemplary only, with a true scope of the disclosure being indicated by the following claims and their equivalents

What is claimed is:

1. A battery, comprising:
a positive electrode:
a negative electrode:
a separator disposed between the positive electrode and the negative electrode;
a heat-resistant layer having tetrapod-shaped surface morphology disposed between the separator and at least one of the positive electrode and the negative electrode; and
an electrolyte,
wherein the positive electrode, the negative electrode, the separator and the heat-resistant layer are soaked in the electrolyte.

2. The battery as claimed in claim 1, wherein the heat-resistant layer comprising:
0.1-60 parts by weight of tetrapod-shaped powders; and
0.1-30 parts by weight of a binder.

3. The battery as claimed in claim 1, wherein the heat-resistant layer is coated on the positive electrode or the negative, electrode.

4. The battery as claimed in claim 1, wherein the heat-resistant layer is coated on the positive electrode or the negative electrode, and the heat-resistant layer has a first side facing towards the positive or negative electrode, and a second side facing towards the separator, wherein the first side has a porosity smaller than the second side.

5. The battery as claimed in claim 1, wherein the heat-resistant layer is coated on the separator.

6. The battery as claimed in claim 1, wherein the heat-resistant layer is coated on the separator, and the heat-resistant layer has a first side facing towards the separator, and a second side facing towards the positive or negative electrode, wherein the first side has a porosity smaller than the second side.

7. The battery as claimed in claim 2, wherein the tetrapod-shaped powders have rods each of which has a length of 10 nm-5 μm, and a diameter of 10 nm-2 μm.

8. The battery as claimed in claim 2, wherein a material of the tetrapod-shaped powders comprises Zn, Sn, Me, AL Si, V, Zr, Ti, Ni, alloys thereof, oxides thereof, nitrides thereof, carbides thereof, or combinations thereof.

9. The battery as claimed in claim 2, wherein the binder comprises polyvinylidene fluoride, polyhexafluoropropylene-polyvinylidene fluoride, ethylene-tetrafluoroethylene, polychlorotrifluoroethylene, polyvinyl acetate, polyvinyl alcohol, polyethylene oxide, polyvinyl pyrrolidone alkylated polyethylene oxide, polyvinyl ether, polymethylmethacrylate, polyethylacrylate, polytetrafluoroethylene, polyacrylonitrile, resins with acrylonitrile unit, or combinations thereof.

10. The battery as claimed in claim 2, wherein the heat-resistant layer is prepared by using a solvent comprising N-methyl-2-pyrrolidone, methyl isobutyl ketone, methyl ether ketone, ketone, methyl ethyl ketone, toluene, xylene, mesitylene, fluorotoluene, difluorotoluene, trifluorotoluene, N,N-dimethylacetamide, or combinations thereof.

11. The battery as claimed in claim 1, wherein the heat-resistant layer has a thickness of 0.1 μm-20 μm.

12. A method of manufacturing a heat-resistant layer, comprising:
mixing 0.1-60 parts by weight of tetrapod-shaped powders, 0.1-30 parts by weight of as binder, and 99.8-10 parts by weight of a solvent to form 100 parts by weight of a dispersion and
processing the dispersion into a heat-resistant layer with tetrapod-shaped surface morphology between a battery electrode and a separator.

13. The method of manufacturing a heat-resistant layer as claimed in claim 12, wherein the step of processing the dispersion comprises processing the dispersion to form the heat-resistant layer has tetrapod-shaped surface morphology, and then disposing the heat-resistant layer has tetrapod-shaped surface morphology between the battery electrode and the separator.

14. The method of manufacturing a heat-resistant layer as claimed in claim 12, wherein the step of processing the dispersion comprises directly coating the dispersion on the battery electrode or the separator, and then drying the coated dispersion to form the heat-resistant layer has tetrapod-shaped surface morphology.

15. The method of manufacturing a heat-resistant layer as claimed in claim 14, wherein the drying is carried out at a temperature of 30° C.-150° C.

16. The method of manufacturing a heat-resistant layer as claimed in claim 12, wherein the tetrapod-shaped powders has rods each of which has a length of 10 nm-5 μm, and a diameter of 10 nm-2 μm.

17. The method of manufacturing a heat-resistant layer as claimed in claim 12, wherein material of the tetrapod-shaped powders comprises Zn, Sn, Mg, Al, Si, V, Zr, Ti, Ni, alloys thereof, oxides thereof, nitrides thereof, carbides thereof, or combinations thereof.

18. The method of manufacturing a heat-resistant layer as claimed in claim 12, wherein the binder comprises polyvinylidene fluoride, polyhexafluoropropylene-polyvinylidene fluoride, ethylene-tetrafluoroethylene, polychlorotrifluoroethylene, polyvinyl acetate, polyvinyl alcohol, polyethylene oxide, polyvinyl pyrrolidone, alkylated polyethylene oxide, polyvinyl ether, poly methylmethacrylate, polyethylacrylate, polytetrafluroroethylene, polyacrylonitrile, resins with acrylonitrile unit, or combinations thereof.

19. The method of manufacturing a heat-resistant layer as claimed aced in claim 12, wherein the solvent comprises N-methyl-2-pyrrolidone, methyl isobutyl ketone, methyl ether ketone, ketone, methyl ethyl ketone, toluene, xylene, mesitylene, fluorotoluene, diflurorotoluene, trifluorotoluene, N,N-dimethylacetamide, or combinations thereof.

20. The method of manufacturing a heat-resistant layer as claimed in claim 12, wherein the heat-resistant layer has a thickness of 0.1 μm-20 μm.
